(19) United States
(12) Patent Application Publication
(10) Pub. No.: US 2025/0265946 A1
(43) Pub. Date: Aug. 21, 2025

(54) PROTECTIVE CASING FOR SECURING AND DISPLAYING AN AUTOGRAPHED ITEM

(71) Applicant: Guillermo Peralta Birrueta, Tustin, CA (US)

(72) Inventor: Guillermo Peralta Birrueta, Tustin, CA (US)

(73) Assignee: ProGuard Collectibles LLC, Tustin, CA (US)

(21) Appl. No.: 18/442,683

(22) Filed: Feb. 15, 2024

(51) Int. Cl. G09F 1/12

(52) U.S. Cl. CPC G09F 1/12

(57) ABSTRACT

A protective casing specially adapted for holding cards and memorabilia during signature collection enables securing an item while allowing signing access is disclosed. The enclosure comprises of a base with item-sized recessed pocket and a transparent cover with cutouts aligned over an autograph area. Snapping together, integrated tension clips, locking edges or a hinge securely but removable joint the two segments. In the closed position, a card or item cannot shift while tightly encapsulated toward outer edges yet remains visible. Cutouts provision barriers only around the targeted pen access space rather than fully exposing delicate surfaces. This enclosure provides collectors display protection through transportation, public queues and handler contact at conventions or events.

### FIELD OF THE DISCLOSURE

The present disclosure relates to a protective display enclosure for retaining collectible cards or memorabilia during the process of obtaining a signature. It allows visibility of the item while securing it from damage via a two plate snap enclosure with an signing access window.

### BACKGROUND

Trading cards, especially rare and high value collectibles, require meticulous protection and handling to maintain their condition, value and appeal to collectors. However, opportunities often arise for fans and collectors to obtain prized celebrity signatures directly on their cards or memorabilia items at conventions, red carpet events and sports games. This creates a major challenge—removing a card from its protective sleeve to be autographed risks scratches, bending, smudging or other handling damage from the signer. Equally, inserting the signed item back into a case risks the same issues. Even careful autograph seekers may accrue edge wear, surface scuffs or visibility obscured by top loader cases.

Prior art enclosures for displaying collectibles are predominantly focused on protective storage and visibility. While suitable for protection, typical rigid screw-down cases do not allow external access to the surface of an encapsulated card. Some prior attempts have been made to create hybrid display cases with holes or cut-outs allowing partial surface access, however these open the rest of the card to potential bending or abrasion damage. Additionally, most collectors would hesitate to disassemble expensive rigid protection cases in public settings to remove a card for signing purposes.

Therefore, there is an unmet market need for an improved protective system tailored for the signature gathering process, one that can fully secure and support a card while allowing safe direct access to a section of the surface for marker pen autographs. Therefore, an object of this invention is to describe a durable yet portable enclosure specially designed for retaining and displaying collectible cards or memorabilia during an autographing event while preventing any handling, edge, or surface damage that could impact a prized item's condition, appearance or value.

### SUMMARY

One aspect of the present disclosure relates to a protective enclosure for securing a collectible card or memorabilia while displaying it for autographing access. This comprises a rigid base plate featuring a recessed portion sized to fully contain the item to be encased. Shock-absorbing cushioning lines this recessed area for surface protection. A transparent cover attaches to the base aligning over the recessed portion, sandwiching the encapsulated item. The cover includes one or multiple openings, windows or cutouts sized and positioned to expose an area of the surface underneath for a signature.

In the closed position, the enclosure may employ snap-fit connectors, locking tabs, tension clips or an integrated hinge joining the protective base and cover. This securely maintains the item without slipping or abrasion while still allowing repeatable opening access and visibility. Some embodiments may integrate a kickstand or easel on the rear base for angled surface presentation to the signing celebrity. Optional tapered edges or silicone bumpers act as shock absorbers in case of drops.

Alternative securing methods can utilize magnetic closures along the rim instead of mechanical press-fit. An additional embodiment features a sleeve, portfolio or multi-page style folio binder incorporating storage pockets to include the protective display casings.

The enclosure is crafted from materials like acrylic, polycarbonate or layered foam cores sandwiched between thermoplastic sheets. Dimensions are adaptable to standard card sizes or irregular collectible shapes through modular base plate and cover pairings. The design aims to provide complete edge, corner and surface protection while enabling marker pen access through a signing portal customized to the encapsulated item. All handled edges are smoothed and rounded. The casing serves as certified protection for high-value collectibles throughout conventions, auctions and celebrity events.

The disclosed enclosure system solves the problem of displaying prized cards for autographs without requiring removal from a protective case. By facilitating signing access while preventing any handling or environmental damage, it provides the ideal solution for collectors transporting rare items to public venues.

### BRIEF DESCRIPTION OF THE DRAWINGS

FIG. 1 illustrates a system configured for community-based parking management.

FIG. 2 illustrates an exploded view perspective of the protective casing components.

FIG. 3 illustrates a perspective of the protective enclosure with the cover plate 102 arranged in an open position.

FIG. 4 illustrates a view of a person signing a card in a protective casing.

FIG. 5 illustrates an autographed memorabilia exhibited within the assembled protective enclosure casing.

FIG. 6 illustrates an autographed memorabilia not enclosed in the protective casing.

### DETAILED DESCRIPTION

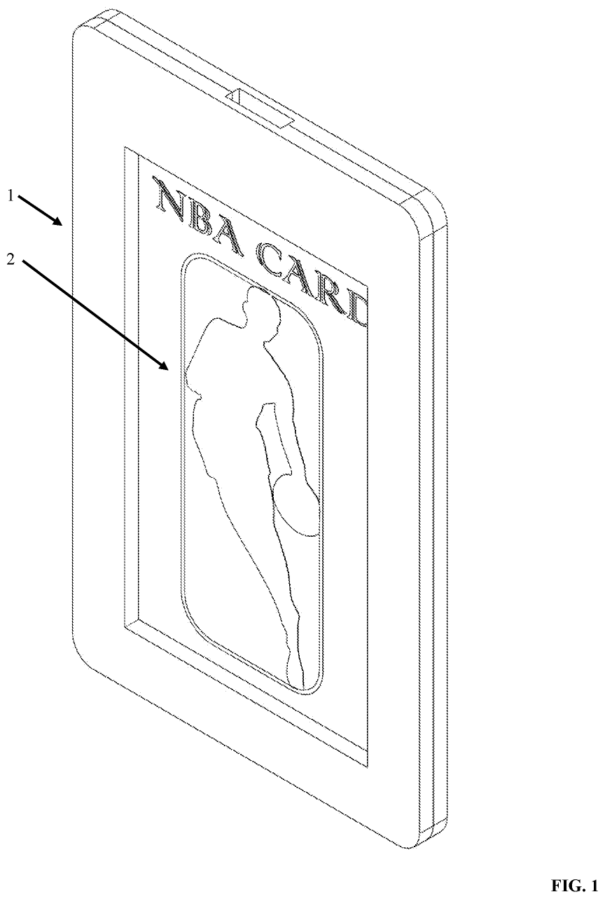

FIG. 1 depicts a perspective view of a protective casing 1 for securing a card, memorabilia or other collectible item 2 according to one embodiment. The rigid casing 1 features a base plate with a recessed portion sized to fully contain the collectible item 2 to be protected. A transparent cover plate snaps into place over top the base plate, sandwiching the item 2 between the plates while leaving signed portions exposed. An autograph access cutout on the cover plate overlaps a portion of the encapsulated item 2. The smoothed casing 1 edges and tight cover protect the retained content item 2 from environmental exposure or handling damage.

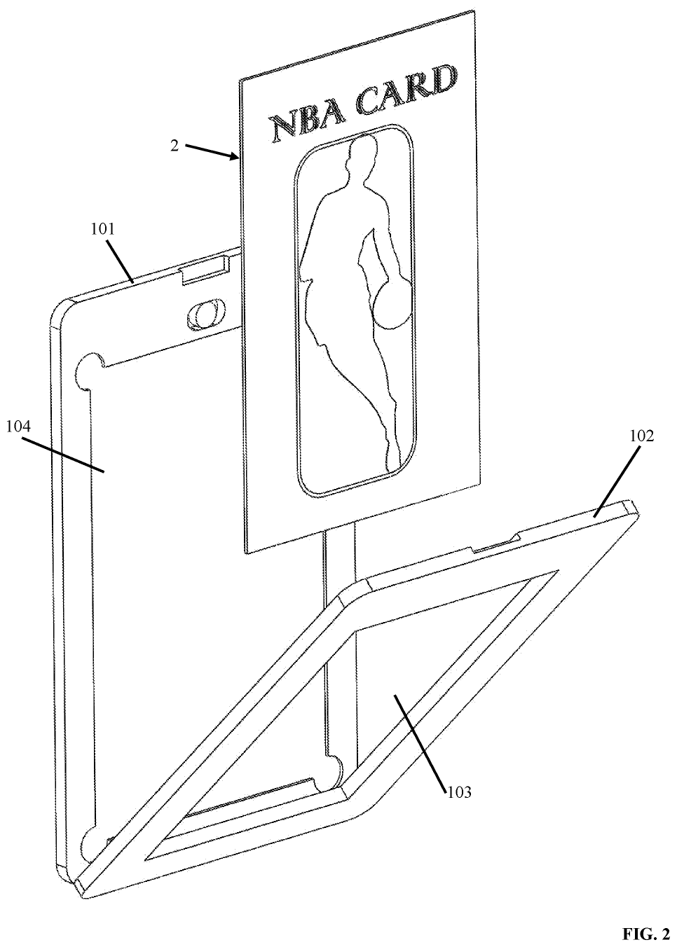

In another aspect, FIG. 2 shows an exploded view perspective of the protective casing components according to one embodiment. The base plate 101 features a rectangular recessed portion 104 that is indented into the plate with the same dimensions as a standard or non-standard trading card. This recessed portion 104 provides an area to fully contain and support the card, memorabilia or other collectible item 2 that is to be protected. The edges around the recessed portion 104 are raised to securely grip the item 2 when enclosed.

The cover plate 102 is crafted from optically clear plastic or acrylic to provide transparency and visibility of the encapsulated item 2 in the closed casing, with its dimensions matching the periphery of the base plate 101 recess 104. An opening 103 is cut out from the transparent cover plate 102 in a shape and size designated to expose a specific portion of the surface of item 2 where an autograph is intended to be applied.

To assemble the protective enclosure, the item 2 is inserted into the recessed portion 104, then cover plate 102 snaps into place aligning over the base recess while leaving the item area exposed through opening 103. This securely retains the item 2 for transport and handling while allowing visibility and access through cover cutout 103 for collecting signatures without removing it from protective custody.

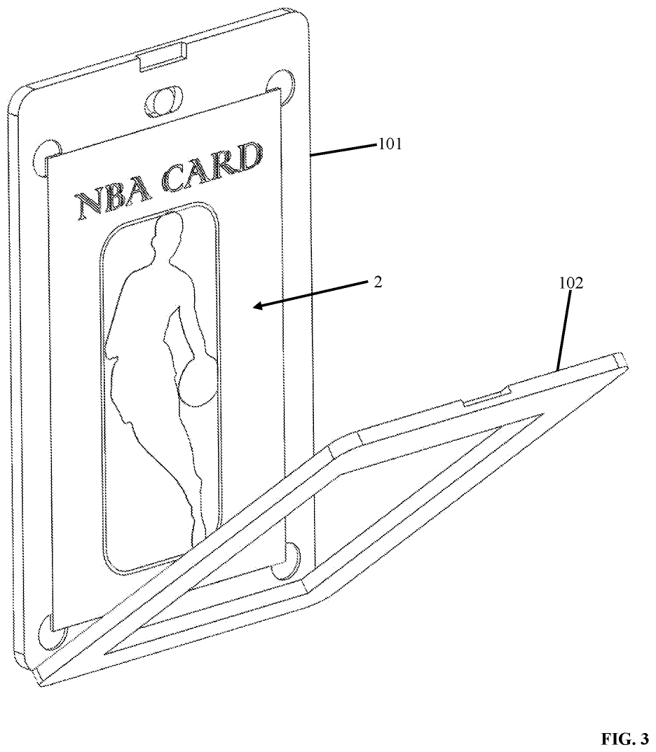

According to another illustrative aspect, the FIG. 3 illustrates a perspective of the protective enclosure with the cover plate 102 arranged in an open position, exposing the interior recess portion of base plate 101 containing a secured card item 2. When closed, these two plates 101 and 102 seal together on opposite sides of item 2 to fully encapsulate it.

Here the transparent cover plate 102 is disengaged from the base plate 101 and pivoted upright, allowing the recessed portion and any card memorabilia 2 housed inside the cavity to be clearly visible. This recessed containment area within base plate 101 features indented sides that correspond precisely to the dimensions of the item 2 in order to press up flush against its edges for maximum surface protection when enclosed. Interior cushioning lining the recessed walls provides further item safeguarding.

This open casing view demonstrates the process of inserting or removing a card, autographed puck or other enclosed collectible 2 into the base plate recess or lifting it out post-signing. The tight recess chamber stores the content 2 securely with no slipping while the transparent hinged cover 102 allows continual content visibility even when latched shut. FIG. 3 emphasizes the insertion/removal and complete item 2 protection functions when cover 102 reconnects base 101 to shield the surface from environmental exposures, abrasions or unprotected handling while still retaining access through designated autograph regions.

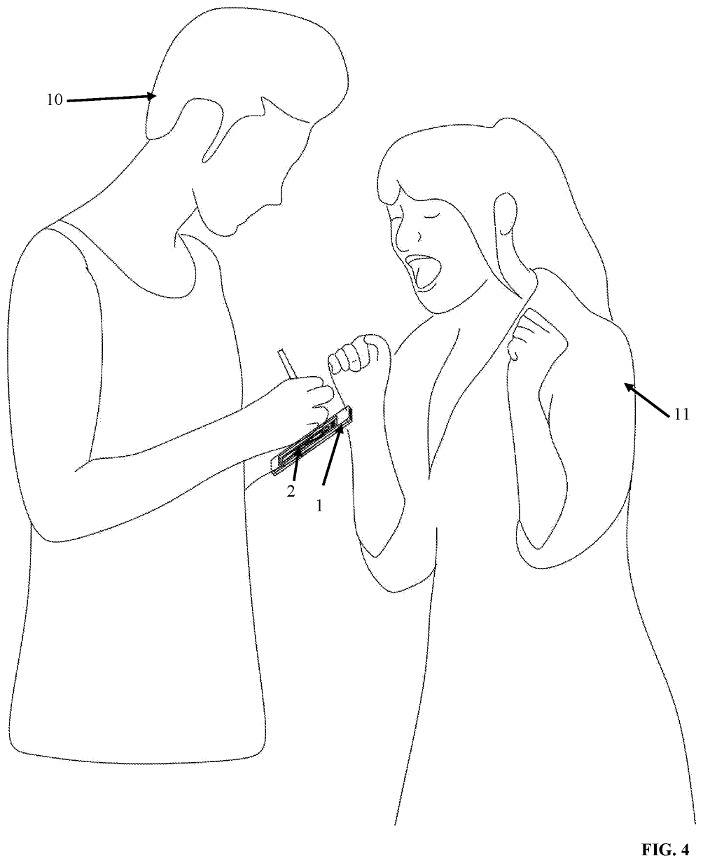

Further, the FIG. 4 depicts the protective enclosure casing 1 demonstrated in a real-world autograph signing usage, with a card or collectible item 2 safely encapsulated within while a person 10 is shown mid-signature on the exposed item surface area.

The casing's base and cover plates securely grip the memorabilia 2 around the edges, retaining it in the aligned recess pocket while keeping handles portions protected. An suitably-shaped opening on the transparent cover grants nib access but barriers elsewhere continue guarding delicate areas prone to smudging or scratches during transportation where jostling may occur.

The signing 10 is witnessed by a fan/collector 11 who retains custody throughout the event. Cutout dimensions and placements are customizable to the anticipated signature location to minimize broad exposure beyond the pen target zone.

By facilitating a signature directly on an encapsulated item 2 without fully removing it from protective custody, the invention provides collectors a means to obtain prized celebrity autographs on cards, jerseys or equipment without risking damage en-route or during complex public venue logistics. After signing, the item 2 remains secured inside the padded chamber without further handling or vulnerability. The transparency allows admiring the new signature while the casing 1 ensures the collectible grade is maintained.

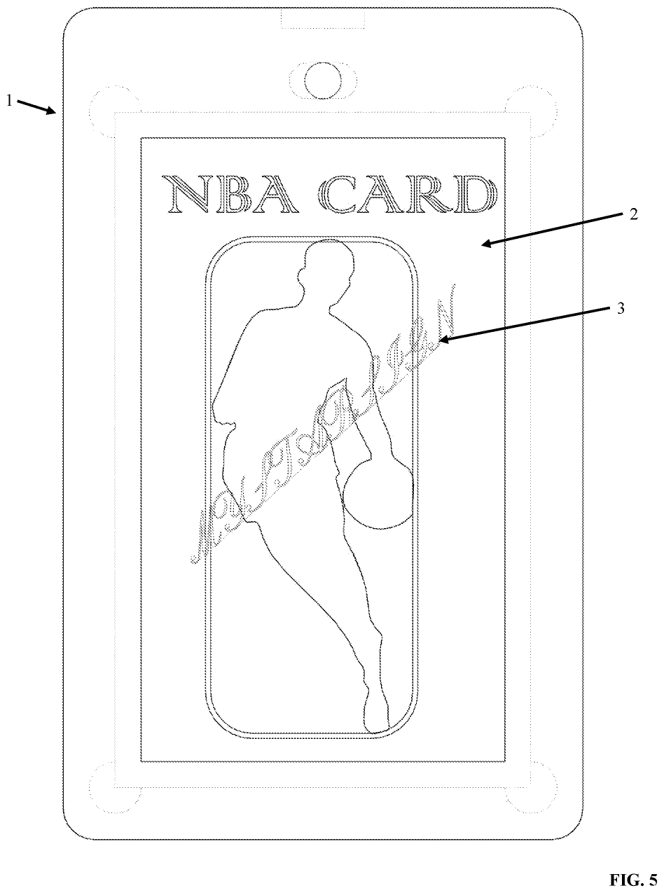

In another aspect, FIG. 5 presents a side-on vertical illustration of a trading card, autographed memorabilia or other collectible item 2 exhibited within the assembled protective enclosure casing 1 after signature gathering. It demonstrates the card 2 housed securely within the mated base and cover plates, showcasing the newly obtained autograph 3 through the transparent window cutout on the front casing cover.

In this closed position, the card 2 sits protected by padded cavity walls that press firmly against both surfaces to prevent slippage, abrasion or edge damage while retaining visibility of the face through the clear cover. The crisp autograph 3 is captured cleanly upon the trading card 2 with no surface marring or bleeding outside the pen access area, because of to the enclosure cutout dimensionally limiting exposure exclusively to the signature location zone. No handling or environmental wear arose during the signing assembly process or from transit jostling en-route to the event.

By fully encapsulating the card 2 through transportation then strategically permitting signing access only on selective areas, the invention uniquely enables collecting a pristine autograph 3 upon a high-value collectible without ever fully removing it from a protective housing or allowing contact that could scratch, dent or deteriorate a prized item's condition. The transparency provides admiring while maintaining the quality seal verifies authenticity, provenance and grade.

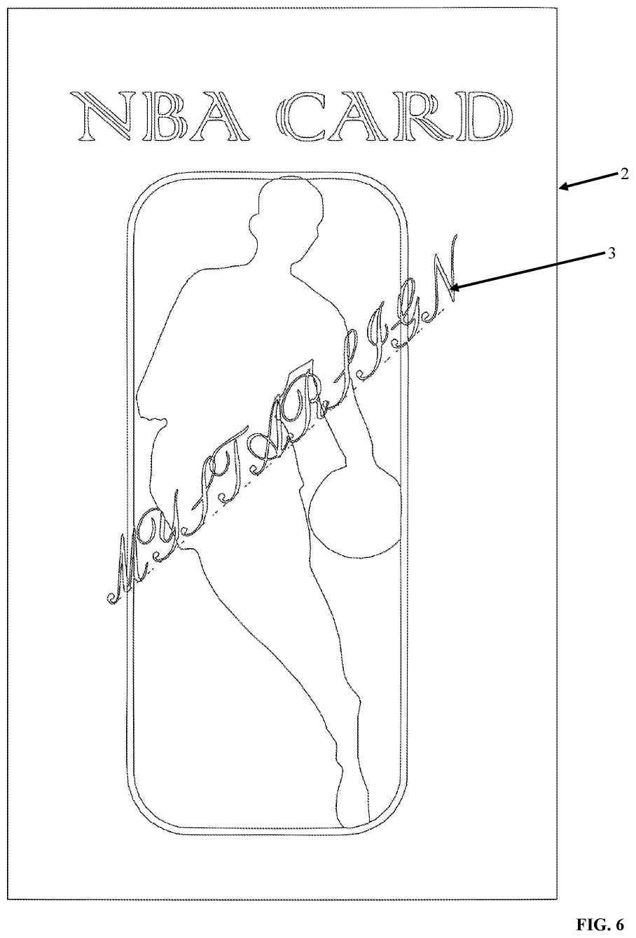

In another aspect, the FIG. 6 provides a comparison showcase of an autographed card or memorabilia item 2 in the absence of the protective casing invention. It illustrates the vulnerabilities, risks, and potential damages to signed collectibles when exposed without enclosure through the signing process and transportation.

The standalone card 2 exhibits a signature 3 by a celebrity guest, overlapping the printed photo. While desired by collectors, without protective measures, collecting these autographs can compromise condition and monetary value. Exposed handling can gradually or instantly imprint scuffs, scratches, dents, fraying, and dog-ears upon fragile, susceptible cardstock surfaces and edges. The lack of securing provision allows slipping, abrasive friction against neighboring items, bending or crimping during frequent loading/unloading cycles from standard rigid card holders. Human error by the celebrity signee introduces the possibility of signatures exceeding intended boundaries, obscuring key imagery. Smudging or imprinted grime from environmental debris may also manifest.

The present invention alleviates such condition damaging threats through numerous techniques including: shock-absorbing interior cushioning linings; rounded, smoothed handling edges; customized recessed cavities; non-slip retaining friction and dedicated transparent autograph cutout portals limiting visibility exclusively to pen target regions. Coupled display easels permit ideal item angles for signing. Alternative embodiments feature interlocking embodiment sleeves or multi-page collector album binders integrating protective casing storage slots for entire collections. The enclosed construction facilitates safe repeated transport after initial autograph events to prevent deteriorating condition from handling or abrasion over time.

Certain embodiments incorporate at least one hinge member between the base plate and cover plate allowing the enclosure to be opened and closed.

Certain embodiments incorporate at least one set of cooperating snap fit connectors on the base plate and cover plate for repeatable securing of the enclosure in a closed position.

Certain embodiments incorporate shock-absorbing padding lining interior surfaces of the base plate recessed portion.

In other embodiments, the cover plate's cutout window extends to edges of the cover plate.

Certain embodiments incorporate a stand member on an exterior surface of the base plate, configured to display the enclosure in an upright angled position during autographing.

Certain embodiments incorporate cushioning material lining interior surfaces of the base plate recessed portion for protecting the retained article.

Certain embodiments incorporate rounded or tapered shapes as shock absorbers.

Certain embodiments incorporate snap fit whereby connectors comprise magnetic components along the rim of the base plate and cover plate for removable securing of the enclosure.

Certain embodiments incorporate a portfolio binder for storing a plurality of protective enclosures having integrated sleeve pockets or multi-page formatting for enclosure insertion and removal.

Certain embodiments may describe a protective casing molded, formed, or machined from materials selected from plastics, acrylics, polycarbonates, resins, foams, composites and laminate sheets.

What is claimed is:

1. A protective enclosure for retaining an article to be autographed comprising:
a base plate having a recessed portion sized to receive the article;
a transparent cover plate configured for removable mating engagement with the base plate, the cover plate overlaying the recessed portion; and
at least one opening in the cover plate sized to provide access to a portion of the retained article for application of an autograph.

2. The protective enclosure of claim 1, wherein the base plate and cover plate are connected by at least one hinge member allowing the enclosure to be opened and closed.

3. The protective enclosure of claim 1, further comprising at least one set of cooperating snap fit connectors on the base plate and cover plate for repeatable securing of the enclosure in a closed position.

4. The protective enclosure of claim 1, further comprising shock-absorbing padding lining interior surfaces of the base plate recessed portion.

5. The protective enclosure of claim 1, wherein the at least one opening in the cover plate comprises a cutout window extending to edges of the cover plate.

6. The protective enclosure of claim 1, further comprising a stand member on an exterior surface of the base plate, configured to display the enclosure in an upright angled position during autographing.

7. The protective enclosure of claim 1, sized to fully enclose trading cards, photographs, or autographed memorabilia articles in standard sizes and dimensions.

8. The protective enclosure of claim 1, further comprising cushioning material lining interior surfaces of the base plate recessed portion for protecting the retained article.

9. The protective enclosure of claim 1, wherein edges along handled portions incorporate rounded or tapered shapes as shock absorbers.

10. The protective enclosure of claim 3, wherein the snap fit connectors comprise magnetic components along the rim of the base plate and cover plate for removable securing of the enclosure.

11. A portfolio binder for storing a plurality of protective enclosures of claim 1, having integrated sleeve pockets or multi-page formatting for enclosure insertion and removal.

12. The protective enclosure of claim 1, molded, formed, or machined from materials selected from the group comprising of: plastics, acrylics, polycarbonates, resins, foams, composites and laminate sheets.
